(19) United States
(12) Patent Application Publication
(10) Pub. No.: US 2010/0042456 A1
(43) Pub. Date: Feb. 18, 2010

(54) Integrated market-based allocation of resources within an enterprise

(75) Inventors: Kai H. Stinchcombe, Menlo Park, CA (US); Gregory Piesco-Putnam, Menlo Park, CA (US)

Correspondence Address: VAN PELT, YI & JAMES LLP, 10050 N. FOOTHILL BLVD #200, CUPERTINO, CA, 95014, US

(73) Assignee: IncentAlign, Inc.

(21) Appl. No.: 12/459,863

(22) Filed: Jul. 7, 2009

Related U.S. Application Data
(63) Continuation-in-part of application No. 12/381,525, filed on Mar. 11, 2009.
(60) Provisional application No. 61/078,732, filed on Jul. 7, 2008.

(51) Int. Cl. G06Q 10/00

(52) U.S. Cl. 705/8

(57) ABSTRACT

Allocating acquired resources within a firm is disclosed. The ability to list acquired resources of a firm on an internal marketplace is provided. A purchasing power asset is divided among the prospective users of an acquired resource of the firm. An intra-firm market enabling prospective users of an the acquired resource of the firm to attempt to obtain the acquired resource by offering to provide an offered amount of the purchasing power asset in exchange for receiving the acquired resource is provided.

### CROSS REFERENCE TO OTHER APPLICATIONS

This application is a continuation in part of co-pending U.S. patent application Ser. No. 12/381,525 entitled PRICING, ALLOCATING, ACCOUNTING AND DISTRIBUTING INTERNAL RESOURCES USING A MARKET MECHANISM filed Mar. 11, 2009, which is incorporated herein by reference for all purposes. This application claims priority to U.S. Provisional Patent Application No. 61/078,732 entitled METHOD AND APPARATUS FOR INTEGRATING MARKET MECHANISMS WITH OTHER SYSTEMS AT A FIRM filed Jul. 7, 2008 which is incorporated herein by reference for all purposes.

### BACKGROUND OF THE INVENTION

Typically, a division, unit, business, group of related or cooperating businesses, or other organizational entity acquires resources for the use of its personnel in performing tasks for the organizational entity. Examples include human resources, such as employees, contractors, and service providers contracted to perform defined services for compensation agreed upon between the service provider and the organizational entity; non-human resources, including raw or intermediate materials, components and subcomponents, or other factors of production; outsourced services such as copying and printing; purchased or leased equipment; and internally developed and/or created equipment, materials, tools, services, and the like. In many cases, such acquired resources are used within the organizational entity by multiple users, who compete within the organizational entity for such resources, for example in the budgeting, planning, and/or other internal decision making of the organizational entity.

### BRIEF DESCRIPTION OF THE DRAWINGS

Various embodiments of the invention are disclosed in the following detailed description and the accompanying drawings.

Embodiments of the present invention are illustrated by way of example, and not limitation, in the figures of the accompanying drawings in which:

FIG. 1 illustrates an overview of an embodiment of the present invention, and a detail of the Market Mechanism which the present invention integrates with other systems at a firm;

FIG. 2A illustrates the operation of a currency system, which defines and permits users to make bids and tracks the amount they are to be debited;

FIG. 2B is a flow chart illustrating an embodiment of a process for determining an exchange rate or other multiplier to be used to perform transfers between accounts denominated in dissimilar currencies, real or private.

FIG. 2C is a flow diagram illustrating an embodiment of a process for estimating demand based on internal currency markets.

FIG. 2D is a flow chart illustrating an embodiment of a process for performing a transfer or reconciliation involving internal accounts denominated in dissimilar currencies, one or both of which may comprise an internal, private currency such as described herein.

FIG. 2E is a flow diagram illustrating an embodiment of a process for monitoring and controlling an internal exchange rate, e.g., between two types of internal currency or as between an internal currency and a national or other external currency.

FIG. 3A illustrates an estimate system, which produces estimates of cost and work to accomplish a project, and a multiplier system which allows cost estimates to be incorporated in bids;

FIG. 3B is a flow diagram illustrating an embodiment of a process for generating component bids on components of a project.

FIG. 4A illustrates a bid set system which allows users to place multiple bids for a request to accomplish the same task;

FIG. 4B is a flow diagram illustrating an embodiment of a process for receiving and evaluating a bid set.

FIG. 5A illustrates a bargain hunting system which matches bids within bid sets to resources;

FIG. 5B is a flow diagram illustrating an embodiment of a process for implementing bargain hunting;

FIG. 6A illustrates a bid-clearing system that identifies when bids stored for evaluation must be cleared from the market mechanism;

FIG. 6B is a flow diagram illustrating an embodiment of a process for clearing bids.

FIG. 7A illustrates a valuation system that associates resources with their value as defined by bids, the operation of the market mechanism, and other factors;

FIG. 7B is a flow diagram illustrating an embodiment of a process to determine the value of acquired resources within a firm or other organizational entity.

FIG. 8 illustrates a resource flow system, which coordinates the flow of resources across boundaries in a way that increases value;

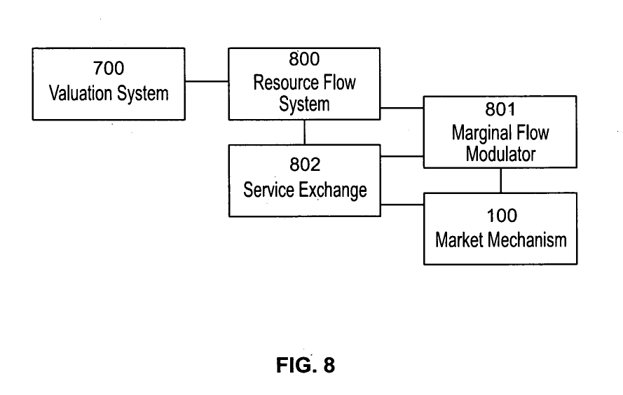

FIG. 9 illustrates a business intelligence feed which aggregates, stores, and presents information to interested parties; and

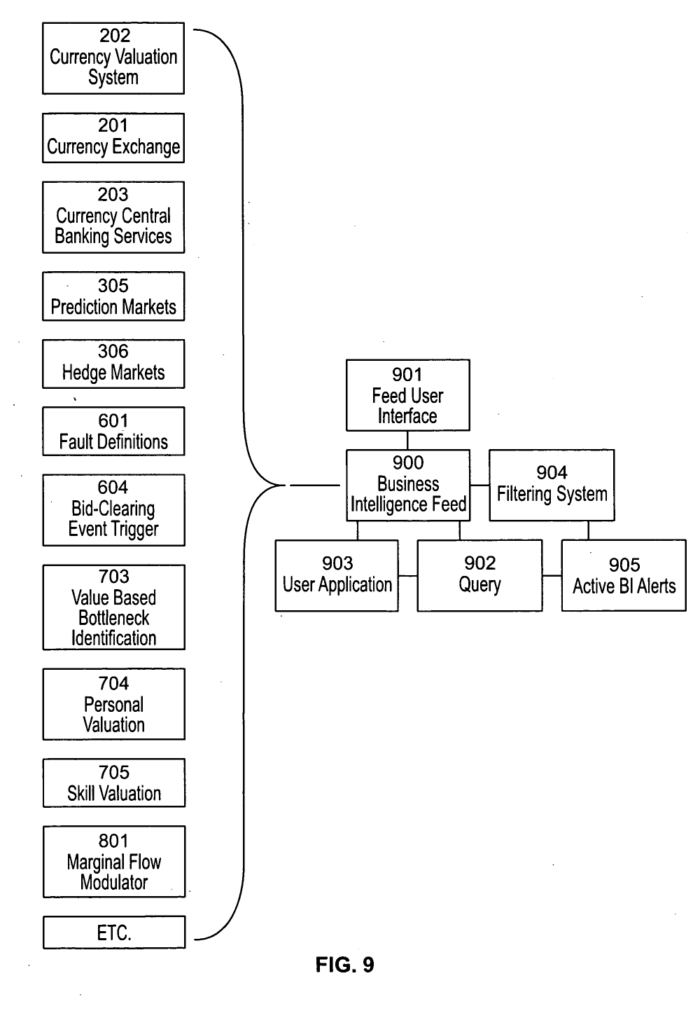

FIG. 10 illustrates user architecture upon which the processes described herein are able to transmit and receive data.

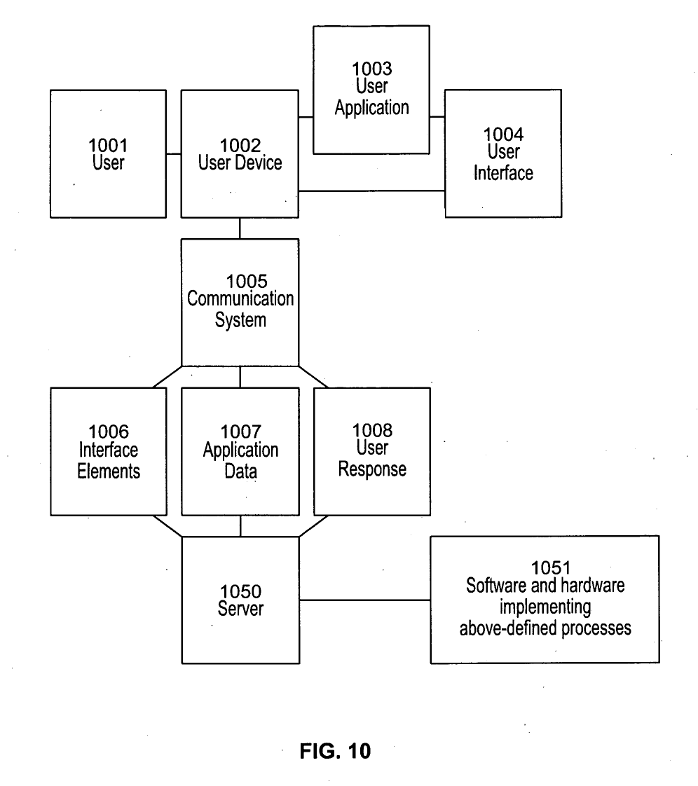

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A market-based allocation within an organizational entity of acquired resources of the organizational entity is disclosed. In some embodiments, a resource requestor within an organizational entity submits a request for an acquired resource of the organizational entity. The request includes a bid indicating an amount of a purchasing power asset that the requestor is willing to provide in exchange for receiving the requested resource. In some embodiments described herein, the purchasing power asset comprises a private, internal currency usable within the organizational entity to acquire resources, e.g., specified resources or resources of a particular type associated with the private currency. For example, “IT bucks” may be used to bid for information technology (IT) support services from IT service providers who work for or have already been contracted in an external market to provide services for the organizational entity. The bid is compared with other bids, from competing requestors, to determine a priority of the requestor's request relative to the respective requests of the competing requesters. Requests are fulfilled in an order determined at least in part on the respective priorities unless/until a supply of the acquired resource is exhausted, in which cases requests associated with losing bids remain unfulfilled.

As used herein, the term “organizational entity” refers to any defined entity that acquires resources outside the organizational entity, for example on the open market, for use by personnel and/or other users of the organizational entity, and may include without limitation a business, governmental, non-governmental, or other entity; a division, unit, or other defined organizational subdivision of a business or other entity; and/or a group of businesses or other entities organized to operate at least in part in concert, including by acquiring resources for use by personnel of the combined and/or cooperating entity.

An “acquired resource” as used herein includes any resource, human or otherwise, acquired by an organizational entity from a source outside the organizational entity for use of the personnel and/or other users of the organizational entity. Examples include, without limitation, employees, contractors, or others retained to provide services within the organizational entity to personnel of the organizational entity, e.g., information technology (IT) support services; printing, word processing, administrative, and other support services; and non-human factors of production, for example particularly scarce and/or high value materials and/or components. An acquired resource may be purchased or hired in advance, for example on the open market, or contracted for in advance at a rate or other price agreed upon (or determined later in a manner agreed upon in advance) between an outside provider and the organizational entity. Once acquired, in the approach disclosed herein acquired resources become available to be requested by personnel or other users of the organizational entity for use within the organizational entity to perform and/or facilitate a task for the organizational entity. For example, IT services acquired by an organizational entity, by hiring IT staff and/or contracting for IT support services from a provider outside the organizational entity, are used by personnel of an organizational entity to ensure their computers are available to be used to perform work of the organizational entity. In the approach disclosed herein, a market-based mechanism is used to allocate acquired resources among personnel or other users of an organizational entity competing within the organizational entity for the use of such acquired resources, as described more fully below.

### Market Mechanism

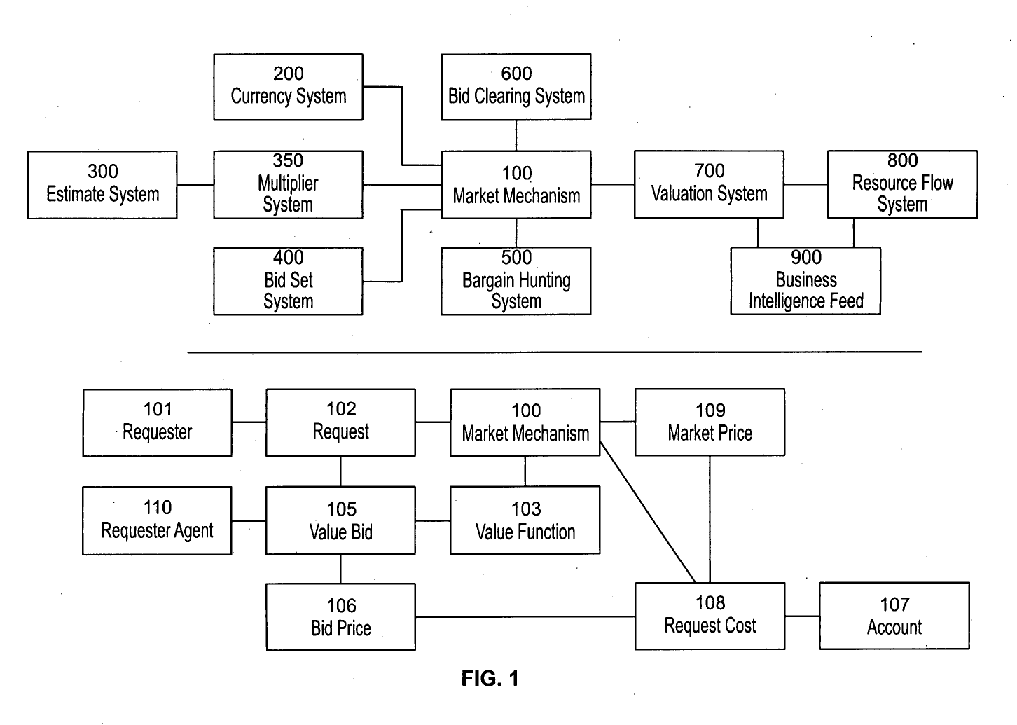

The Market Mechanism (100) illustrated in FIG. 1 is an apparatus, system, or process within a firm or other organizational entity that allows a person or group of persons associated with the firm, the Requester (101), to place Requests (102) for goods or services, from among the goods and services offered to persons associated with the firm to support its activities, and which matches some subset of those Requests to a collection of the goods and services available to the firm. The Market Mechanism may store these Requests (102) or evaluate them immediately.

In some embodiments, this Market Mechanism is a Value Based Market Mechanism. The Value Based Market Mechanism contains a static or changing Value Function (103) which is used to compare different possible matchings of subsets of requests to collections of goods and services, and determine which is preferable.

Some Value Functions may associate with each Request a Value Bid (105), a single or set of ordinal values representing data that may be used to evaluate the importance, priority, value, or need for a given Request.

The Value Bid may be defined not by the Requester (101) but by a Requester Agent (110). For example, the requester may be an external customer, client, or partner; and the requester agent may be the internal customer support agent, account manager, or business development manager who is responsible internally for ensuring that the needs of the requester are met. Without limitation, this may be implemented in customer relationship management software.

One element of the Value Bid (105) may be a promise, called a Bid Price (106), to make a payment, debit, transfer, or reduction in an Account (107) —a budget line, resource pool, account, or other numeric tracking system internal to the company—by or on behalf of the Requester; with the amount promised being an ordinal value that can be directly compared, summed and compared, multiplied by relevance, goodness of fit factors, an increasing or decreasing decay rate, or inputted with a plurality of other factors into some other Value Function. Some fraction or function of the Bid Price, the Request Cost (108), may be deducted instead of the Bid Price itself from the Account. The Bid Price (106) represents how much the Requester is willing to pay, e.g., in the form of a specified quantity of an internal, private currency or other purchasing power asset, while the Request Cost (108) represents how much is actually to be deducted.

In one embodiment, a Value Bid might be a single bid price representing the amount of money the Requester is willing to deduct from his or her budget line, or a collection of budget lines controlled by joint requesters, at the firm in order to cause the requested service to be fulfilled, and the Value Function might simply be the sum of Value Bids. In this case the Value Based Market Mechanism would select the set of collectively attainable Requests that maximizes this sum, and match them to the available resources.

In one embodiment, a Market Price (109) for each resource may exist, varying over time. For example, the Market Price (109) may reflect how others recently have value the resource in the market, or may be a measure of how valuable other uses to which the resource might otherwise be or have been put are, as determined by the market. In some embodiments, if the Bid Price (106) is greater than the Market Price (109) at the time the bid is evaluated, the bid is successful. Sometimes, the Request Cost (108) is then set to the Market Price (109). In other systems, the Market Price (109) may be a rate (e.g. an hourly rate) and may be multiplied by the amount of work done or some other amount to calculate the Request Cost (108). The Request Cost (108) may also be calculated a different way.

### Currency System

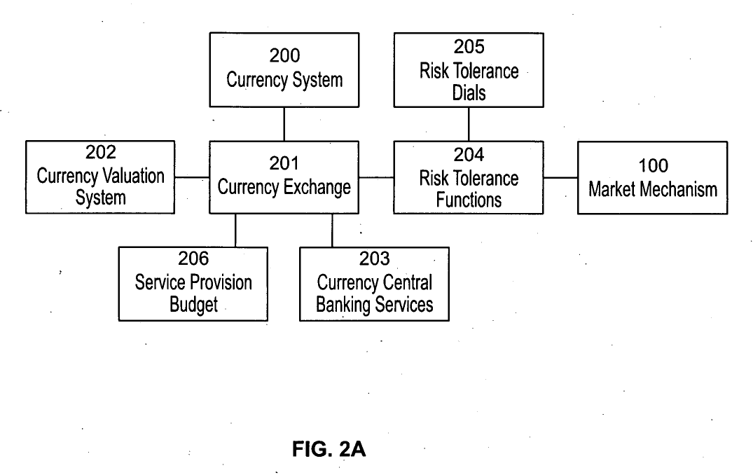

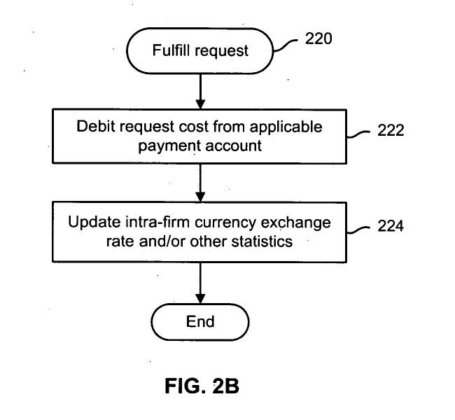

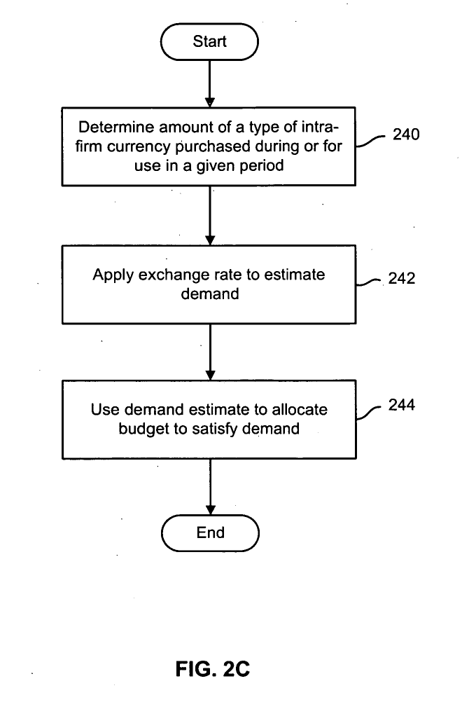

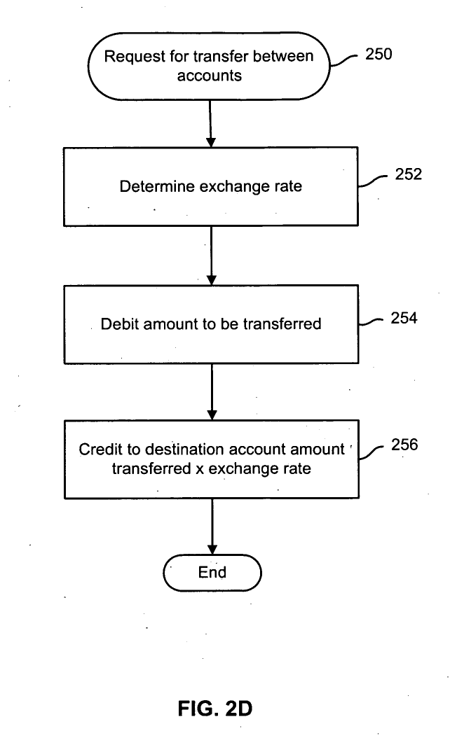

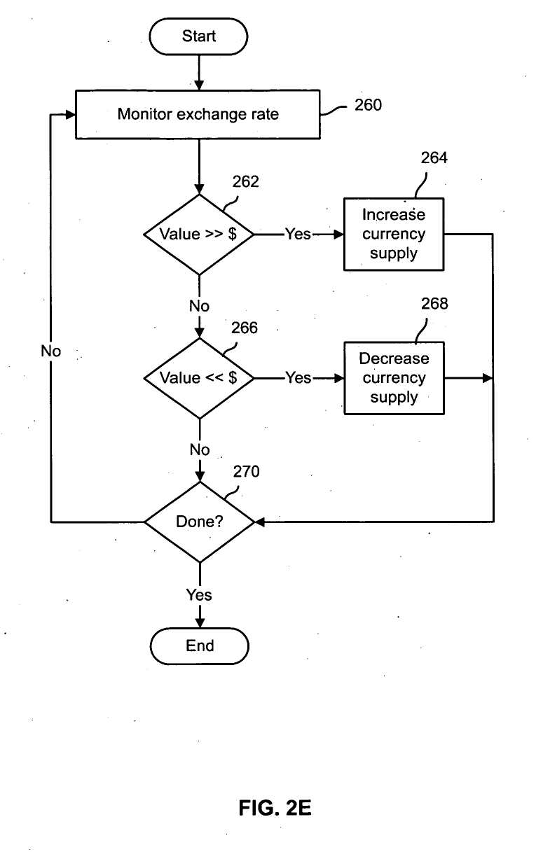

The Currency System (200) illustrated in FIG. 2A is a set of processes and components that assist in some embodiments in the management of currency which may be bid in Bid Prices (106) for the Market Mechanism (100).

A Currency Exchange (201) may be employed to assist in the preparation of Value Bids containing Bid Prices. Specifically, Request Costs are debited from a specific set of Accounts, for example accounts containing allocated or otherwise acquired amounts of an internal, private currency or other purchasing power asset or other consideration made available for use to compete for acquired resources of the organizational entity.

The Currency Exchange (201) in various embodiments comprises a set of processes that allow appropriate persons or processes at the firm to:
permit those with permission to debit an account within the firm's accounting software to Transfer money from a general project, division, or business unit account into a subset of accounts at the firm from which Request Costs are drawn (for example, to make a transfer from the project budget to the project's IT budget, from which IT Request Costs may be deducted) or to Transfer money from a Request Cost dedicated budget to a broader budget (for example, to make a transfer from a project's IT budget to its main balance) or to Transfer money directly between different types of Request Cost dedicated budgets (for example, from a project's Marketing Budget to its IT Budget). In the case of a plural Requester, (for example a joint project between marketing and sales, in which ⅔ of the costs are to be borne by marketing and ⅓ by sales) the Account may be a joint account created specifically for the purpose; an abstract Account which in fact draws from the two accounts; an individual pledge or Account or Bid from each, independently, which are added to produce the joint Bid; or some other system;
cause a Reconciliation of Request Costs deducted from an Account, by reducing the amount of the overall remaining budget for that project, division, or business unit;
in the process of this Transfer or Reconciliation, apply a multiplicative factor or another numeric function, for example so that one unit within the dedicated IT budget costs 1.1 unit deducted from the broader budget, based for example on a determination that IT account dollars (or other real or pseudo currency or other IT purchasing power asset) have been determined in an internal market for IT services to have greater purchasing power, in terms of value obtained, than the (real or internal) currency in which the broader account is denominated;
track, monitor, and record these Transfers and Reconciliations, at a plurality of levels of aggregation, so that individuals, managers, and executives are aware of changing demand for and use of different types of resources, and the source of that demand and use;
permit and revoke permission for certain persons at the firm to engage in Transfers and Reconciliations from different Accounts and for different types of services;
calculate what the budget, remainder, total, total expenditure, profit, or margin would have been using a different numeric function to Transfer or Reconcile Request Costs, whether in real time, retrospectively, or prospectively, for different types of services; for the purpose of calculating financial or nonfinancial incentives for employees, managers, and other persons or groups;
use different units, dimensions, symbols, or nomenclature for numbers representing units in different types of budgets, accounts, or tracking systems, for example “IT dollars” or “COMPANY bucks”; define and indicate one-to-one convertibility among some types of accounts and not others using this nomenclature (e.g. “IT bucks” can be converted one-to-one among Help desk and Application development accounts because they share a common symbology; however they are not the same as “Legal Service bucks” which may be used for a different set of purposes and may not be 1:1 convertible);
use the amount of currency purchased to estimate demand and define the budget for service provision (206). For example, if divisions purchase $100m of “IT dollars”, the firm may decide it is appropriate for the IT division to have a $100m budget to provide the services requested; or a budget of $90m to reflect the internal rate of return; or some other related number. Alternatively, the total transfers for one period (Q1, 2009) may be used to set the budget for the following period (e.g. Q2, 2010).

The numeric function applied by the Currency Exchange (201) for Transfers and Reconciliations may be set through a Currency Valuation System (202), which is a system and process that defines and measures the value of units within each type of account. For example, if an “IT dollar” is valued at 1.1 standard dollars, a multiplicative factor of 1.1 would be applied to Transfers and Reconciliations to IT dollars. This valuation might be estimated based on the ratio of IT spending (or some subset of IT spending, for example variable costs or project costs, or an estimated valuation of the market price of services provided) to the sum of Bid Prices or the sum of Request Costs. For example, if 200,000 “IT dollars” are bid for 300,000 U.S. dollars worth of services, an “IT dollar” may be valued at $1.50.

FIG. 2B is a flow chart illustrating an embodiment of a process for determining an exchange rate or other multiplier to be used to perform transfers between accounts denominated in dissimilar currencies, real or private. In the example shown, when a request is fulfilled (220) an associated Request Cost (e.g., an amount based on the bid price, market price, etc.) is debited from an associated payment account(s) (222).

In various embodiments, one or more auction or other market mechanisms are used to determine the Request Cost to be charged. For example, in some embodiments, a Vickrey auction is used. The number of simultaneous resource requests that can be met is determined. For example, if there are ten service employees on duty and each service request requires two employees, then five service requests can be met simultaneously. The requests associated with the corresponding highest number of requests, e.g., five the foregoing example, are determined and designated as the prioritized bids. For each of the prioritized (successful) bids, the resource price is determined to be equal to the bid price associated with the highest unsuccessful eligible bid.

Another available pricing process is the rolling Vickrey auction, which is a modified version of the Vickrey auction. In this approach, a set of bids beyond the set of currently competing bids is considered in order to set the resource price to be charged to successful bidders in a way that fluctuates less, or in a more predictable manner. For example, the resource price may be determined based at least in part on the average of the most recent five (actual or hypothetical) Vickrey auctions for resources of that type. The rolling Vickrey auction may combine or “roll together” bids that are alike in several different ways; for example, it may combine the five most recent bids for similar services, the five most recent bids for similar services on a similar day or at a similar time of day, etc.

Another method that may be used is the market-clearing auction. In that approach, the services or other resources that would be eligible over the course of the next Z number of hours is determined, and the Vickrey auction process is used to set the price for them all at once, and then schedule them as possible over the course of the next Z hours, for example in priority order based on their respective competing bids.

A fourth process to determine resource price to be charged is the first-price auction, which simply returns the highest bids as the prioritized service bids, each with its corresponding bid amount as the price charged to that requesting user.

While specific market mechanisms to determine the price to be charged to successful bidders are described above, in various embodiments any market mechanism that determines which resource requests have the highest priority and what the resource price should be charged to successful bidders may be used.

Referring further to FIG. 2B, once the payment account has been debited (222), applicable intra-firm currency exchange rate and/or other statistics are updated (224). For example, the Request Cost denominated in units of an internal currency (e.g., “IT bucks”) may be compared to a corresponding external cost to fulfill the request, denominated in a national or other reference currency, to determine an exchange rate. For example, as noted above, if 200,000 “IT dollars” are bid for 300,000 U.S. dollars worth of services, an “IT dollar” may be valued at $1.50.

FIG. 2C is a flow diagram illustrating an embodiment of a process for estimating demand based on internal currency markets. In the example shown, an amount of an acquired resource-type specific intra-firm currency (e.g., “IT bucks”) that has been purchased or otherwise acquired by internal users to the resource to compete for access to the acquired resource during and/or for use in a given period (e.g., month, quarter) is determined (240). An exchange rate, e.g., determined as described herein, is applied to determine a demand estimate denomination in units of a national or other reference currency (242). The demand estimate is used to determine an amount of the acquired resource to acquire and/or otherwise make available to be acquired via the internal market mechanism during the same or a future period (244). For example, if managers of various consuming divisions have acquired 100,000 IT bucks for use during the next quarter, and the IT bucks have been determined to each be worth $2.00 (i.e., each IT buck has been determined to be usable to acquire $2.00 worth of IT services via the market mechanism), then $200,000 in IT services are acquired and/or otherwise made available within the firm for that quarter.

FIG. 2D is a flow chart illustrating an embodiment of a process for performing a transfer or reconciliation involving internal accounts denominated in dissimilar currencies, one or both of which may comprise an internal, private currency such as described herein. In the example shown, when a transfer is requested or a reconciliation required (250), an applicable exchange rate is determined (252)—e.g., 1 IT buck is worth $2.00; an amount to be transferred is debited from the payment (source) account, denominated in the currency of that account (254); and a destination account is credited in an amount determined by applying the exchange rate to the amount debited from the payment account (256). For example, a manager may be permitted to transfer an amount from an overall project budget, denominated in dollars, to an IT account for the project. In such an example, if an IT buck has been determined to be worth $2.00, then a transfer to $200,000 from a broader project (or other) account to an IT account may result in 100,000 IT bucks being credited to the destination account. In another example, total project costs may be tracked by reconciling a project budget with transfers from accounts designated and used to obtain acquired resources of the firm, for example by deducting $200,000 from a project budget denominated in U.S. (or other) national currency if 100,000 IT bucks, each determined to be worth $2.00, are used to acquire IT services within the firm.

Another approach to setting a multiplicative factor to be applied in the Currency Exchange (201) uses the Currency Central Banking Services (203) system. This system allows the value of different types of accounts to float relative to one another, and allows other types of control over the value stored in accounts. The Central Banking Services system (203) enables those with appropriate permissions to:
determine the current amount of outstanding currency in each type of budget;
sell new currency of a given budgetary type in an auction to determine the exchange rate for that type of budgetary account;
purchase currency of a given budgetary type in an auction to determine the exchange rate for that type of budgetary account;
split by a given ratio or factor all outstanding currency in a given type of account or dedicated to a given purpose;
provide a “stimulus package” giving currency in a given type of account to each business unit based on a defined formula;
charge or give “interest” on outstanding amounts in a given type of accounts;
inflate or deflate the value of a given type of account by expanding or decreasing the supply of it.

FIG. 2E is a flow diagram illustrating an embodiment of a process for monitoring and controlling an internal exchange rate, e.g., between two types of internal currency or as between an internal currency and a national or other external currency. In the example shown, an exchange rate for an internal currency is monitored (260). For example, as noted above as the internal currency is used to obtain acquired resources of the firm, the request costs, of individual requests and/or collectively, are compared to the external or other underlying cost, denominating in an external or other dissimilar currency to determine based on market transactions an exchange rate for the internal currency. If the value of the internal currency is determined to be more than a predetermined threshold amount greater than the reference currency (262), then steps are taken to increase the supply of the internal currency within the firm (264). For example, additional amounts of the internal currency may be made available for bid, purchase, and/or otherwise allocated within the firm. In some embodiments, additional amounts are made available for bid, and the amounts of reference currency bid to obtain the additional amounts of internal currency are used to determine an updated exchange rate for the internal currency. If the value of the internal currency is determined to be less than the reference currency by more than a predetermined threshold (266), then steps are taken to decrease the supply of the internal currency within the firm (268), for example by using reference currency to buy back amounts of the internal currency. In various embodiments, the value of the internal currency relative to the reference currency may be increased or decreased by regulating the available supply of the acquired resource, e.g., authorizing overtime to make more IT technicians available, with the result that fewer IT bucks have to be bid to obtain IT services, or by cutting overtime, assigning dual use resources to an alternative use, or otherwise reducing supply, so that more IT (or other) bucks must be bid to succeed in having a request for IT (or other) services fulfilled.

Finally, Risk Tolerance Functions (204) may be applied either on Transfer or Reconciliation, or when Bid Prices are placed, before comparison. These Risk Tolerance Functions may be applied to budget calculations or to individual or group incentive or bonus calculations. Risk Tolerance Functions are numeric functions applied to Bid Prices, Transfers, and Reconciliations. They may be applied with the knowledge of the person or without. For example a company eager to encourage one division's IT investment might reduce IT-related Reconciliations by multiplying by a factor of 0.75. The Risk Tolerance Functions may also treat incoming revenue or measurements differently; for example, one configuration might expense spending over revenue at 1.2 and spending under revenue at 0.8, and might thereby encourage stakeholders to be highly accountable for targets, while another configuration might credit unexpected revenue at a factor of 1.2 and shortfalls at 0.8, encouraging stakeholders to take risks.

Risk Tolerance Dials (205) allow the executive team to specify different numeric functions for different services, business units, or individuals. In the example above, Risk Tolerance Dials might be used to set one product team in “risk taking” mode and another product team in “high accountability” mode. These dials are a computer-implemented user interface with a series of one-dimensional or two-dimensional inputs in which the user can click, drag, or otherwise input values representing multipliers, coefficients, or function shapes. The inputs may be text boxes, sliders, dials, or any other type of ordinal input. The functions defined by these Risk Tolerance Dials may be defined at successively higher or overlapping business units, with functions either successively applied or with the most specific (lowest level) function taking precedence. For example, an executive might make a division less risk tolerant, increase the risk tolerance of a specific project within that division, and then decrease the risk tolerance of an individual within that project. Successive layers of management may be delegated the power to apply cascading risk tolerance functions; in the example above it might be the CEO making the first decision, the division head making the second division, and the business lead for the project making the third decision.

These risk-tolerance adjusted Value Bids are then fed into the Market Mechanism (100).

### Estimate System

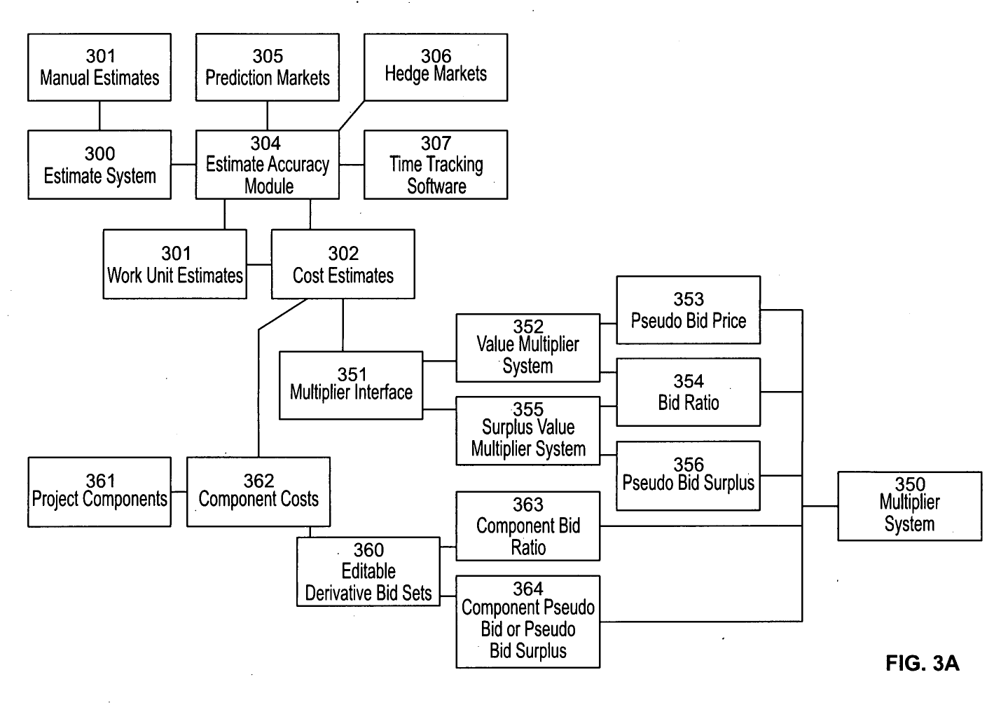

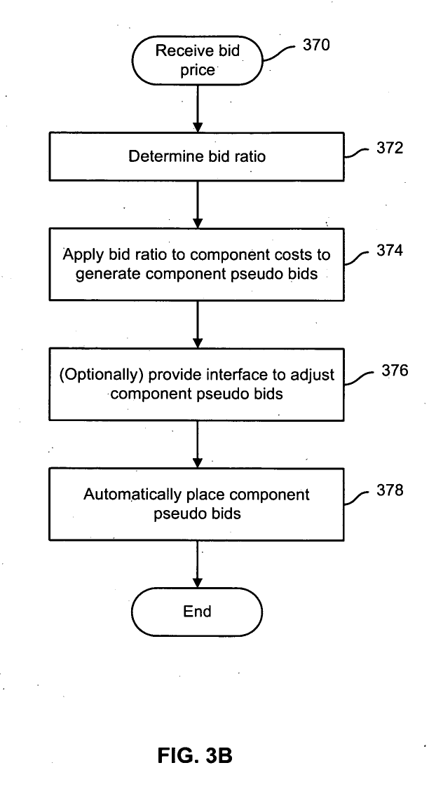

In the process of defining a Request for goods or services, an Estimate may be created that represents the material, time, resources, expenses, and opportunity costs required to fulfill the Request. Often, but not always, this is based on a Manual Estimate (301), a human-created statement of the work required. This Manual Estimate (301) is entered into the Estimate System (300) illustrated in FIG. 3A.

One part of an Estimate may be a Work Unit Estimate (301), which estimates how many units of work (e.g. person-hours, person-weeks, team-months) are required to complete a project or a stage of a project. These units may be estimated by skill-set or individual, e.g. ten hours of a UI designer, ten hours of John Doe's time, or simply “ten hours”.

A Cost Estimate (302) may be created directly or derived from a work Unit Estimate (301). For example, if the internal rate (either marginal or encumbered) for a UI designer is $75, a project estimated at ten hours of a UI designer's time might be estimated at $750.

The Estimates (301 and 302) may also originate in or be filtered through the Estimate Accuracy Module (304), an apparatus and process that helps improve the accuracy of project estimates within the company. In a preferred embodiment it has the following three subsystems, described below, which allow it to do this.

Prediction Markets (305) may be used after a project's specifications are defined to estimate the cost. Under this system, individuals internal to, associated with, or knowledgeable about the company or project may purchase, sell, or trade mock shares or contracts whose value depends on the final calculated price of the project. The market price of the prediction contract can then be a factor used to produce an estimate of the total cost of the project described in the Request.

The prediction market may be subdivided to allow individuals to purchase, sell, trade, or short sell parts of the project; for example guessing that one particular part of a project will take more time or money than is currently expected. Prediction markets may be used in addition to manually-produced cost or work estimates (e.g., the final estimate is 0.6 times the manually-produced cost estimate plus 0.4 times the market-produced cost estimate), or the estimate information may be made available to market participants and then allowed to float, or both methods may be used in combination.

Many firms struggle with containing the costs of project expense overruns and assigning responsibility. Once the Estimates (301 and 302), possibly filtered through the Estimate Accuracy Module (304) are used to estimate the work and cost of a project, and the Estimates have been used to define a Request Cost and Bid Price, a Hedge Market (306) may be used to reduce the uncertainty or risk to the firm of an overrun.

A hedge market allows employees or other persons in connected to, aware of, or in communication with the firm, to purchase mock shares or contracts on the total calculated cost of a project, distributing the reward of an under-budget contract as well as the risk of an over-budget contract. These shares or contracts may be calibrated to have positive, negative, or zero value when sold to employees. For example, if a Request is estimated at $100,000 in cost, 1000 contracts might be sold in the difference between actual and estimated cost. If the Request ends up costing $90,000 when completed, the company would have accrued $90,000 in costs and would pay $10 to each of the 1000 shares' owners, a total of $10,000. Likewise, if the actual cost was $110,000, the 1000 share owners might be charged $10 each, or see their Account or compensation debited $10. In either case, the company accrues a total of $100,000 in cost and is not subject to the risk of the estimate's inaccuracy.

Several steps may be taken to make the hedge market function more successfully:
the market may smoothly transition from a prediction market to a hedge market—in other words, at a certain point the cost of the project is booked, but the price is floating and distributed before and after the project is booked;
the company may retain some of the shares, so it absorbs for example 50% of the risk, with 50% being absorbed privately by persons, organizations and entities associated with the company;
the company may gradually sell shares in the project over the course of its lifetime, so a small number of shares sold to better predict the project's cost may grow to a large number of shares that significantly hedge the project's cost;
the company may define contracts not to exceed a certain amount of loss or gain, or may weight them differently—for example, shareholders are expensed 80% of the project's cost overruns, and 120% of the difference if the project is brought in under budget;
shares may be defined negatively (e.g. the total value of all the contracts is $200,000 minus the cost of the project estimated at $100,000) so that it is unlikely that the value of the contract drops below zero; that way, the company is “cashing out” contracts rather than attempting to collect money from its employees, which may be more difficult;
shares may be given to key managers or stakeholders as a bonus and to encourage the project to come in under budget, which they may or may not be constrained not to buy or sell;
trades may be time-delayed or cleared at a specified or random time period, frozen in the event of swings, or other steps may be taken to avoid dramatic swings and races to buy or sell the contracts in the event of new information becoming available. This allows employees to stay focused on work without constantly seeking to have better information than their fellow employees and thus “beat the market”. Market participants may be prompted to periodically update their price estimates and then trades are executed periodically or continuously by agents based on participant preferences, rather than asking participants to define trades manually.

Finally, the Estimate Accuracy Module may be connected to time tracking software, allowing (a) estimates to be checked against past behavior, (b) information about estimates to be updated or verified in real time, and (c) fill in data about the actual price of contracts, allowing the actual cost to be known.

### Multiplier System

In the presence of a Cost Estimate (302), a Multiplier System (350) illustrated in FIG. 3 may be used to define parts of a Value Bid.

A Value Multiplier System (351) is an apparatus that in various embodiments creates a certain type of Value Bid (105), based effectively on the Bid Ratio between the Cost Estimate and a Pseudo Bid Price, which is measured in the same units as the Cost Estimate (e.g. US dollars). This system is initiated by the Multiplier Interface (351), which operates in some embodiments as follows:

351.1. The Cost Estimate (302) may be presented to the Requester;

351.2. The Requester is then asked to perform one of two actions:

351.2.a to define a Pseudo Bid Price (353) in the same units as the Cost Estimate (302), with the Bid Ratio (354) subsequently calculated effectively as the Pseudo Bid Price (353) divided by the Cost Estimate (302)—for example, if the Cost Estimate is $100,000 and the Requester bids $200,000, then the bid ratio is calculated to be $200,000/$100,000 or 2.0;

351.2.b to define a Bid Ratio (354) as a pure number (e.g. 0.8, 1.1) or on some other linear scale (urgent, somewhat urgent, not very urgent; gold, silver, bronze; expedited, prompt, regular, second rate) whose values correspond to values on a pure number scale; with the Pseudo Bid Price (353) subsequently calculated effectively as the Bid Ratio (354) multiplied by the Cost Estimate (302);

351.3. The Bid Ratio (354) is used to calculate the Bid Price (106) and the Pseudo Bid Price (353) is used to calculate the Request Cost (108).

A Surplus Value Multiplier System (355) operates as the Value Multiplier System, except that the Request Cost (108) is calculated based on Pseudo Bid Surplus (356), the difference between the Pseudo Bid Price (353) as calculated above, and the Cost Estimate (302). In other words, if $250,000 is bid as a pseudo bid price on a project estimated to cost the firm $200,000, the Bid Price (106) entered into the Market Mechanism (100) is the ratio 1.25 and the Request Cost (108) is calculated from $50,000.

In either the Value Multiplier System (352) or Surplus Value Multiplier System (355), any number of other factors may also be used to calculate the Request Cost (108) from the Pseudo Bid Price (353) or Pseudo Bid Surplus (356); for example, in a Vickrey Auction combined with a Value Multiplier System the Request Cost might be calculated based on multiplying the Cost Estimate by the lowest Bid Ratio (354) that would have been sufficient to win the auction; in a Surplus Value Multiplier System combined with a Vickrey Auction the Request Cost (108) would be that minus the Cost Estimate (302).

In the foregoing description of the operation of the Value Multiplier System (352) and Surplus Value Multiplier System (355), “effectively” is used because any approximation of the method described, any increasing or mostly increasing function of the method described, or any approximation of an increasing or mostly increasing function of the method described has an equivalent effect, since the ordinality of the Bid Prices (106), rather than the cardinality, is to be compared.

If a Value Multiplier System or Surplus Value Multiplier System (351) is used to define bids on projects with multiple Project Components, Editable Derivative Bid Sets (360) may be used. This technology operates by the following steps:

360.1. A Bid Ratio and Pseudo Bid Price are defined by the Requester using the Value Multiplier System or Surplus Value Multiplier System (351) based on the Cost Estimate (302), which is divided and itemized among a number of Project Components (361) each with Component Costs (361), which Project Components together essentially make up the Request (work to be done) and whose Component Costs together essentially add up to the Cost Estimate (302);

360.2 The Bid Ratio is multiplied by each of the Component Costs to define a set of Component Pseudo Bid Prices (363), which together add up to the Pseudo Bid Price;

360.3 A set of input mechanisms is made available to the Requester allowing him, her, or them to define new values for the Component Pseudo Bid Price (363) for any item, from which a new Component Bid Ratio (364) is calculated as the ratio of the Component Pseudo Bid Price to the Component Cost; and/or

360.4 A set of input mechanisms is made available to the Requester allowing him, her, or them to define new values for the Component Bid Ratio (364) for any item, from which a new Component Pseudo Bid Price (363) is calculated as the product of the Component Bid Ratio and the Component Cost;

360.5 The components' Pseudo Bid Prices and Bid Ratios are entered into the Market Mechanism (100) and evaluated as though they were individual bids coming from the Value Multiplier System (352) or Surplus Value Multiplier System (355).

Components may be hierarchically defined, so a Request has multiple Project Components (361) each of which may have a plurality of Project Components.

FIG. 3B is a flow diagram illustrating an embodiment of a process for generating component bids on components of a project. In the example shown, an overall (pseudo) bid price for a project requiring multiple component acquired resources of the firm is received (370) and used to determine a bid ratio (372), e.g., by comparing the received bid to an aggregate cost to the firm of the required components. The bid ratio is applied to the known cost to the firm of the component costs, yielding for each component a corresponding calculated component pseudo bid (374). Optionally, the calculated component pseudo bids are presented to the requester (376), e.g., for approval and/or editing or other adjustment. For example, the requester may wish to increase the relative proportion of a total amount bid that is submitted ultimately as a component bid for a particular component that the requester believes will provide a higher value if it is obtained more quickly. Finally, component bids are generated and placed for the respective components (378).

By the use of this process and apparatus, an individual component or part of a project may be speeded up or slowed down independent of other parts of a project. For example, the components needed to be able to demonstrate a technology at a trade show may be accelerated so that they are more likely to be accomplished by the beginning of a trade show, while the rest of the development of the technology may be left to be completed on an ordinary schedule.

The Bid Ratios (354, 363) and Bid Prices or Surpluses (353, 356, 364) are sent to the Multiplier System (360) which communicates these elements of Value Bids (105) to the Market Mechanism (100).

### Bid Set System

In some situations, a Request (102) may be made which could be filled by any element of a set of resources, and each of which resources, in the judgment of the Requester (101), have a different level of suitability for the Requester's purposes. For example, a meeting might require a conference room; with any conference room being sufficient but a conference room with a projector screen being more desirable to the Requester.

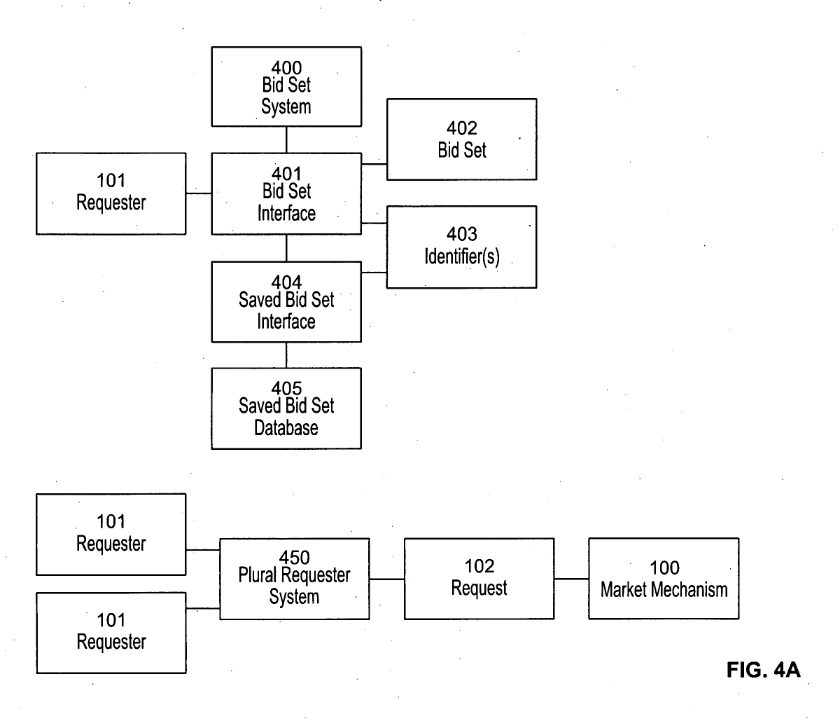

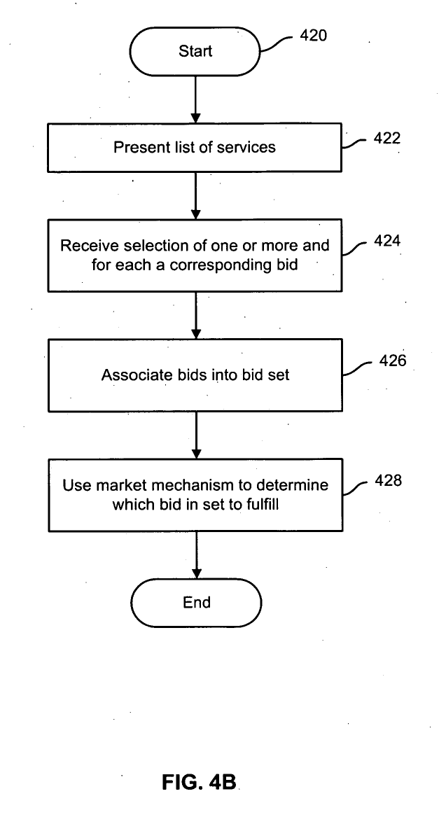

In that case, as illustrated in FIG. 4A, a bid set system (400) includes a Bid Set Interface (401) that is a technology that allows a Requester (101) to list multiple resources and define a Value Bid for each. It functions as follows:

401.1 The Requester is presented with a list of one or more services which may be appropriate to the request and selects one;

401.2 Any user interface element or combination of user interface elements used to allow a single bid to be set may be used to place each bid;

401.3 Further bid slots are added manually or automatically to allow multiple bids to be set;

401.4 The set of bids are associated into a Bid Set (402) and may be tagged with an Identifier (403) to note their common identity, and are then presented to the Market Mechanism (100).

FIG. 4B is a flow diagram illustrating an embodiment of a process for receiving and evaluating a bid set. In the example shown, upon activation of a bid set or other interface (420) a list of available acquired resources is presented (422), e.g., a list of conference rooms and their attributes (e.g., projector or not). A selection of one or more resources and for each a corresponding bid amount are received (424). The bids are associated into a bid set (426) and an intra-firm market mechanism is used to determine which bid in the set to fulfill, i.e., which resource to assign to fulfill the request (428).

In the process of defining a Bid Set (402) for a Request or transmitting a Bid Set to the Market Mechanism, a Saved Bid Set Interface (404) may be activated.

When transmitting a Bid Set (402), the Bid Set Interface (401) may offer the Requester a chance to store a Bid Set. This stored bid set is a representation of the set of resources defined by the user and the bid rates associated with them. The Requester may be offered a chance to define an Identifier for the saved bid set for easy reference at a later date. A default name may be offered, such as “conference room request, May 2005”. The data representation and the Identifier (403) are stored in the Saved Bid Set Database (405).

When defining a Bid Set for a Request, the Saved Bid Set Interface (404) may again be activated. It offers a collection of saved Bid Sets from the Saved Bid Set Database (405). The saved bids may be filtered by the request type (e.g. conference room request, help desk request) and may include Bid Sets saved only by the present Requester or may include Bid Sets from other users as well. The saved Bid Sets may be ordered for convenience, for example the most used or most recently used ones at the top. When the Requester selects a saved Bid Set, the interface may immediately transmit that bid set to the Market Mechanism (100) or it may load it into the Bid Set Interface (401) and allow the Requester to use the interface to modify the Bid Set before submitting it.

### Plural Requester System

In the case of a plural Requester, the Plural Requester System (450) illustrated in FIG. 4 may be used to create a joint bid. The bid may be done in cooperation (for example a joint project between marketing and sales, in which both parties agree that the bid is going to be placed using a Bid Ratio of 1.1, and ⅔ of the costs are to be borne by marketing and ⅓ by sales), or it may be done independently (e.g. marketing bids $100,000 on Project X, and sales bids $200,000 on the same project), or it may be done by some other method. The system may make the other bids visible to each requester, or it may be blind; there may be different types of cooperative bids (e.g. one bidder pays the estimated cost and the second accepts liability for cost overruns), etc.

### Bargain Hunting System

Suppose that the Market Mechanism (100) is configured to use a “Market Rate”, i.e., roughly, finds the price for which the demand above that price is equal to the total supply, and sets the Request Cost for fulfilled Requests for that resource at this Market Rate. This is but one of many examples in which the Request Cost is related to the Bid Price but the two are not equal.

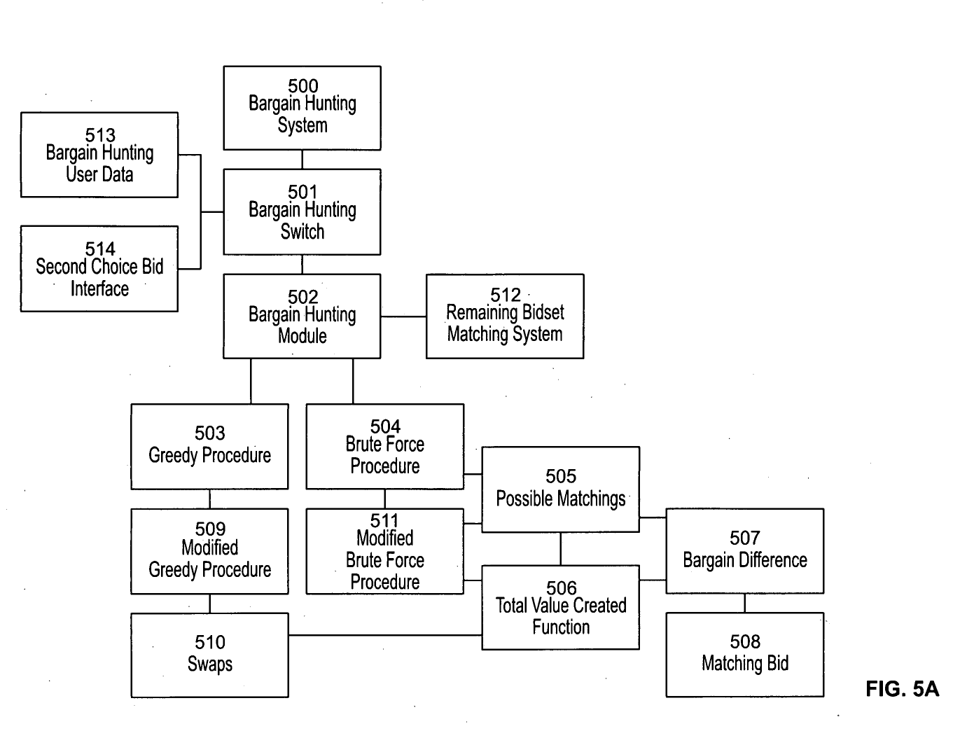

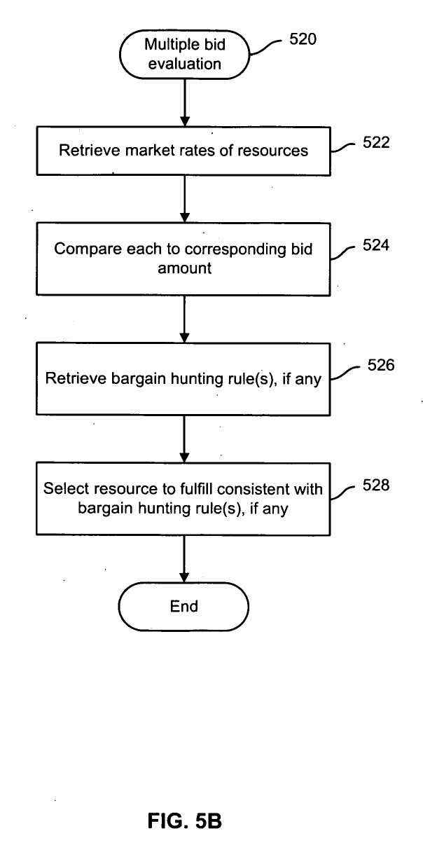

When multiple resources are requested in a Bid Set, and when the Request Cost and Bid Price are not equal, the Market Mechanism (100) may be assisted by the Bargain Hunting System (500) of FIG. 5A in matching resources to requests. The Bargain Hunting Switch (501) is a component of this system which configures the behavior of the Bargain Hunting Module (502).

Suppose a Bid Set is submitted that contains two bids, Resource A for $100 or Resource B for $50. Suppose that the Request Cost for Resource A would be $90 and the Request Cost for Resource B is $25. The Market Mechanism needs to decide whether it is better to give the Requester an item that costs $25 and worth $50 (“$25 in unexpected value! better than $10 in unexpected value!”) or give the requester the item they bid $100 for, at a $90 cost (“I bid $100 for that because that was what I really wanted—don't give me the cheap second choice item!”). A Market Mechanism connected to a Bargain Hunting Switch is able to make this decision.

The configuration of the Bargain Hunting Switch (501) determines which resource will be allocated to the Requester in a situation like that, by operating using the following steps:

501.1 User-defined inputs are entered to represent the relative value of bargains versus value to users—either as a point on a continuum or a simple binary switch between hunting for bargains or picking the most preferred good—using one or more of the following steps:

501.1a A system administrator, or an administrator for each business unit or division is presented with a set of continuums representing the tradeoff, and is asked to define default values on those continuums.

501.1b Each individual is asked to define a preferred level of bargain-hunting, either in the course of each bid request, or defining a default value that may be edited at any time.

501.1c The system may gather Bargain Hunting User Data (513) from user behavior or responses to determine how each individual user, or the set of users as a whole, is expecting the system to interact. For example, if 70% of the time when Requesters get a bargain-hunted bid they elect to cancel the service and place a new bid, while they only do that 15% of the time with most-preferred-good selections, it is clear that the system is tending too far toward bargain hunting.

501.1d There may be a separate Second Choice Bid Interface (514) for placing, within a single bid set, “most preferred” bids and “second choice” bids, either through an element of the bid entry interface or through a separate set of bid entry interfaces for each type, with the understanding that “second choice” bids are not to be substituted for “most preferred” bids if a “most preferred” bid is available. There may be multiple preference levels, for example “if none of my second choice bids work, select a third choice bid”. How users respond to this system may be used to seed Bargain Hunting User Data (513) into the system.

501.2 By one of these methods, firm-wide, for each individual, or for each bid, a weight between hunting for bargains or picking the most preferred good is defined and transmitted to the Bargain Hunting System.

The Bargain Hunting Module (502) is a process that evaluates the bargain-versus-preference tradeoffs in the manner defined by the Bargain Hunting Switch (501). For example, if the switch is set to seek the top preference, a Greedy Procedure (503) may be used, as follows:

503.1: The highest bid in the list of bids available to be considered is loaded for immediate consideration.

503.2: A bid is not considered if the resource it is bidding for is not available, or if another bid within the same bid set has already been filled

503.3: The bid is marked to be filled and some portion of the resource it is bidding for is allocated to fill that bid; and the bid is then removed from the list of bids available to be considered.

503.4: If more bids remain on the list of bids available to be considered, return to step 503.1.

In contrast, if the Bargain Hunting Switch (501) is set to maximize bargains, a Brute Force Procedure (504), which operates as follows, may be used:

504.1: A Possible Matching (505) is defined as a matching of some bids to some resources that does not exceed the availability of the resources or violate any rules of the Market Mechanism (100). A set of Possible Matchings (505) or a process for generating Possible Matchings is defined. This set may be the set of all Possible Matchings (505) or the process may be a process for generating all Possible Matchings (505); or a subset may be used to reduce computational time. For example, the set may include only Possible Matchings that match resources to bid sets that include bids for those resources; or a convergent process may be used that locates promising Possible Matchings and then considers Possible Matchings that are “close” to that promising Possible Matching (i.e. differing from them in a limited set of ways).

504.2: Each Possible Matching is evaluated to determine the total value created, with Total Value Created Function (506) defined as the sum of the Bargain Difference (507), the difference between the market price of the resource matched to the bid and the bid price of the bid in the bid set that corresponds to the resource matched, the Matching Bid (508).

504.3: The Possible Matching (505) that maximized the Total Value Created Function (506) is selected.

If the Bargain Hunting Switch (501) is on the continuum between maximizing bargains and seeking top preferences, either a Modified Greedy Procedure (509), or a Modified Brute Force Procedure (510), may be used.

A Modified Greedy Procedure (509) may be used by taking the output of the Greedy Procedure (503) as a Possible Matching and considering value-increasing Swaps (510). By this method, a set of chains are considered in which Bidset A was assigned Resource 1, Bidset B was assigned Resource 2, and so on through Bidset N which was assigned Resource X; and it is considered to swap each resource down the chain, so Bidset B gets Resource 1, Bidset C gets Resource 2, and so on, and then Bidset A gets Resource X. This potential Swap (510) is considered using a Total Value Created Function (506) as in the Modified Brute Force Procedure, applied to both the original Possible Matching and the Possible Matching defined by applying the considered Swap (510) to the original Possible Matching. If the latter is greater, that Possible Matching is accepted and further Swaps (510) may be considered. The set of Swaps (510) to be considered is substantially smaller than the total number of Possible Matchings, increasing computational efficiency, because only Swaps containing an exchange that creates a positive change in the Total Value Created Function need be considered.

The brute force procedure may be modified, creating a Modified Brute Force Procedure (510), by replacing the Total Value Created Function (506) defined above with a different Total Value Created Function (506). For example, the Function may be 0.75 times the Bargain Difference (507) plus 1.5 times the value of the Matching Bid (508), to create a preference for matching highest-value bids; or it may be 0.75 times the Bargain Difference (507) plus 60 times one divided by the rank-order of the Matching Bid (508) when the bid set is ordered by decreasing value (e.g. 60 for the highest bid in the bid set, 30 for the second-highest bid, 20 for the third-highest bid in the bid set, 15 for the fourth).

FIG. 5B is a flow diagram illustrating an embodiment of a process for implementing bargain hunting. In the example shown, when a bid set is evaluated (520) the respective market cost/rates of the resources bid on in the set are retrieved (522), and each is compared to the corresponding bid amount indicated for that resource in the bid set (524). Bargain hunting rule(s) applicable to the bid set are retrieved (526), for example one or more rules associated with a requester with which the bid set is associated (user indicates user generally wants bargains, user has indicated with respect to this bid set that the user is bargain hunting, etc.), and applied to determine which resource is selected to fulfill the request (528). For example, if the bid set includes a bid of 100 Room Bucks for Conference Room A (with a projector) and 50 Room Bucks for Conference Room B (no projector), and the market based price of Room A is 90 Room Bucks while the price of Room B is only 25 Room Bucks, then if the bid set is associated with a bargain hunting rule or mode, then Room B may be assigned to fulfill the request, even though Room B is clearly the requester's second choice.

Often the Bargain Hunting System may assign only a subset of the Bidsets to resources, with others left unassigned because there is no available resource whose market price is less than the bid price. These Bidsets go in some embodiments to the Remaining Bidset Matching System (512), which uses one of three methods may be used to deal with these remaining bids.

512.1 The bids may remain unfilled—either the bidder needs to increase their bid, or the use of resources is not valuable enough to justify its execution.

512.2 The bids in the bidset may be uniformly, by adding a positive number or multiplying by a number greater than one, increased until the bid is able to be filled.

512.3 The bidset may be filled by an available resource, either at its current market value or for free. The resource may be selected randomly, or because it is the lowest priced resource, because it is the available resource that best fits the need described, because it is the free resource whose typical value relative to other comparable resources best matches the value of the need relative to other comparable needs (e.g. assign a mid-value free manager to a mid-value project, a high-value free manager to a high-value free project), or some combination of these and other factors.

### 600 Bid Clearing System

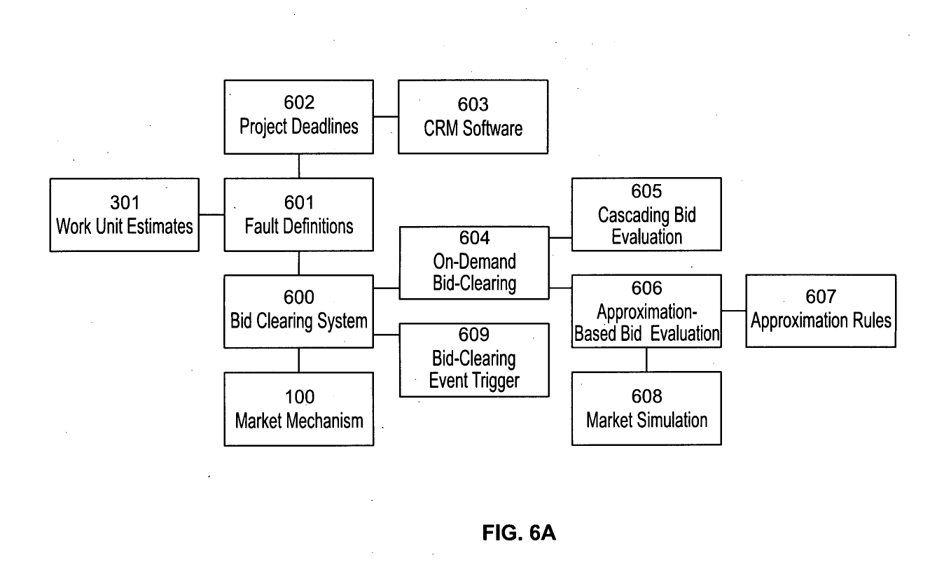

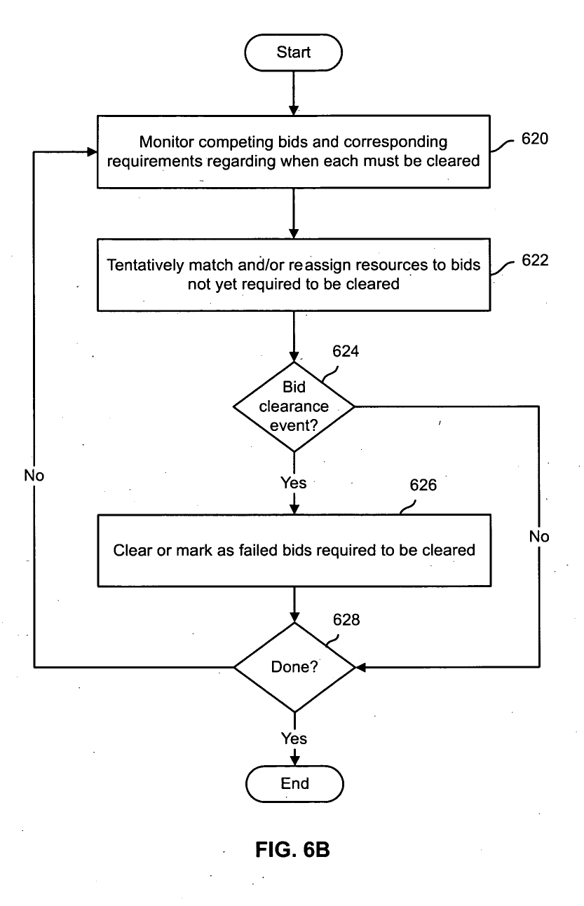

The Bid Clearing System (600) shown in FIG. 6A is a system that avoids three sorts of problems in various embodiments:

(1) If Requests are assigned to resources immediately, at the point when the resource is needed (e.g. at the time the meeting is scheduled to commence, the conference room is assigned), or at some fixed interval between the two (e.g. two hours before the resource is needed), there is likely to be only a subset of resources available at that time. That means that some better-fit resources might have been already assigned to another Request, or become free after this Request is already assigned different resources. Thus, the quality of the resource assigned depends highly on which resources are available at the time the bid is evaluated.

(2) When quality is highly sensitive to when the resource is requested or due, there will be a strong incentive to place a bid at the “right” time, e.g. to place a technical request when a super-star technician has just finished a task. This leads to people investing time in “gaming” the system rather than stating value accurately.

(3) In contrast, if flexibility is reserved by assigning a large number of requests to a large number of resources simultaneously, deadlines or opportunities may be missed.

The Bid Clearing System (600) contains a set of Fault Definitions (601) that define when the system is out of order. For example, Work Unit Estimates (301) may be used to define when an employee is being underworked—when the employee has less than 40 hours a week work to do, for example, or doesn't know what they will be doing five hours from now.

Another set of definitions may come from Project Deadlines (602), which may define a date when a person must be assigned to a project. These Deadlines (602) may be based on communicated customer expectations defined in Customer Relationship Management (CRM) Software (603), for example.

These Fault Definitions (601) are stored in or communicated to the Bid Clearing System (600), which helps identify when bids must be “cleared” by the Market Mechanism (100), i.e. assigned to resources or marked as failed bids and removed from consideration.

In case of a Fault, or in other circumstances, the Bid Clearing System (600) may use On-Demand Bid-Clearing (604) to clear a specific set of bids.

When a set of bids are set to be cleared, the Cascading Bid Evaluation (605) process may be used. This process identifies contingent bids that should be cleared before clearing the identified bids sent to the On Demand Bid Clearing System (600). For example, it may clear all higher bids for the same resource, to determine if there is enough of the resource so that the bid under consideration will be able to secure some of that resource at its current price. When bids within the system are parts of Bid Sets (402), other bids within bid sets which contain bids for the resource being cleared may be evaluated to determine if those Bid Sets should be assigned to different resources.

Second, Approximation-Based Bid Evaluation (606) may be used. This may use Approximation Rules (607). For example, if a bid to be cleared is over 125% of the average market price, or is over the 90% probability range for the historic market price of the resource, that bid may be assigned the resource.

Alternatively, Market Simulation (608) may be used. This approach is similar to Cascading Bid Evaluation (605), except that the other resources are not actually assigned—other bids are not cleared, but the behavior of the market if those bids had been cleared is simulated and calculated. The simulation may be limited (as with Cascading Bid Evaluation) or may simulate the entire operation of the market.

When Approximation-Based Bid Evaluation (606) is used, the Request Cost (108) may be assigned along with the resource, or alternatively, the resource may be assigned based on the estimate that the Bid Price (106) will be greater than the Market Price (109), with the Request Cost (108) defined at a later time, for example when the bid would have been cleared. The Request Cost (108) may be capped by the Bid Price (106) so that if the estimate that the Bid Price will be greater than the market price, the Requester is not “penalized” for the bad estimation. Or the Request Cost may be left uncapped.

Finally, there may be a Bid-Clearing Event Trigger (609). This may be an automatic (periodic or random) or manual trigger that clears all outstanding bids in the system, or some random or predefined subset of the bids; or it may be responsive to an accumulation of faults.

FIG. 6B is a flow diagram illustrating an embodiment of a process for clearing bids. In the example shown, pending requests (bids) and associated requirements for clearing same (e.g., requested fulfillment dates or other deadlines) are monitored (620). Bids not yet required to be cleared but for which a suitable matching resource is available are matched tentatively with a corresponding resource (622). The match is tentative in the sense that over time as other requests are submitted and/or other resources become available, some tentatively matched resources may be reassigned (tentatively or otherwise) to other requests, for example to determine the overall assignment of resources to pending requests that maximizes value for the firm. Upon occurrence of a bid clearance event (624), e.g., one or more bids are set to expire, or will generate significantly less value if fulfilled later, one or more bids (which may or may not have been tentatively matched previously with corresponding resources) are cleared, or marked as failed bids if the time for clearing them and no suitable resource not already committed to another, higher value use is available to fulfill the request(s) (626). The process continues, with resources being tentatively matched with pending requests and bids being cleared or marked as failed as bid clearance events occur, until done (628), e.g., the internal market is closed.

### 700 Valuation System

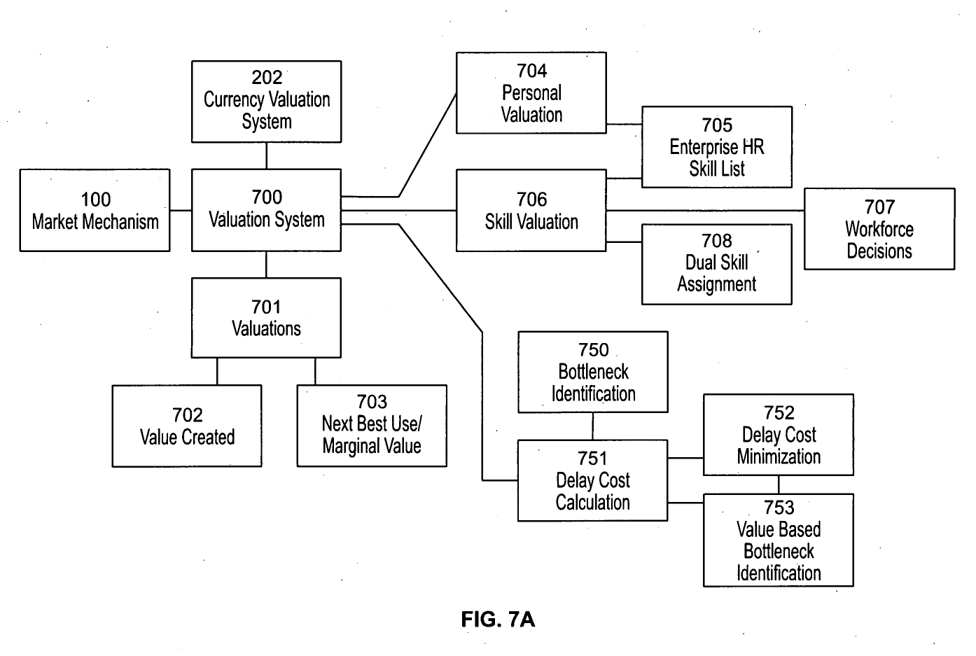

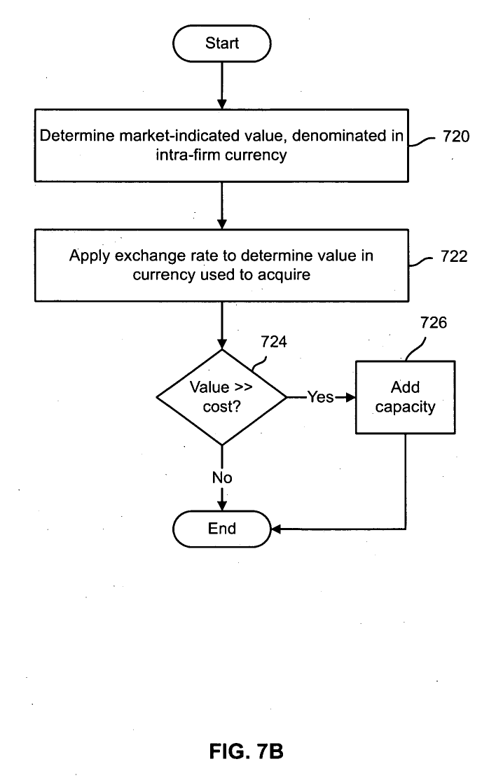

The Valuation System (700) of FIG. 7A comprises in some embodiments a set of computer processes that uses data from the Market Mechanism (100) to establish the value of different things within the firm. When properly configured, Bid Prices (106) fed into the Market Mechanism (100) represent an accountable estimate of how much value the resource bid on has to the firm.

If currency controls are implemented on which accounts may be bid from, the Valuation System (700) begins by reading the value of currency from the Currency Valuation System (202). If ordinary currency (e.g. the US Dollar) can be freely used to define Bid Prices from ordinary Accounts, the value of currency is already established and this step is unnecessary.

Valuations (701) of resources available in the market may be determined, at various stages in the process, by any of the following metrics:

701.1 Top bid

701.2 Average winning bid

701.3 Average bid

701.4 Value Created (702)—e.g. bid rate times number of hours worked at that rate

701.5 Next Best Use/Marginal Value (703)—e.g. if you had one more hour (one more person-week per week, etc.) of this person's time or the time of this person's skill set, what is the bid price of the bid that could be realized; or “if there are N persons with this skill available, what would have been the value captured by N−1 persons”

701.6 Market price—any other rate set by the Market Mechanism

When the resources bid on are individuals (e.g. employees, contractors, consultants, managers) the Valuations (701) are Personal Valuations (704) which may be used to help determine or target incentives, identify areas for improvement (e.g. if an employee is poorly valued for one task among the four tasks they are responsible for), and make personnel decisions.

When the resources are more general skill-sets (e.g. UI designer, C coder) or are targeted to a general workforce (e.g. help-desk ticket responses, hiring requests by the human resources department), or when an Enterprise HR System containing a Skill List (705) is available to match individuals with skills, Skill Valuations (706) are established. These can be used to make Workforce Decisions (707) using a marginal value valuation (703). This is done as follows:

707.1 Skill Valuations indicate the value an additional employee of that type would add to the company.

707.2 An estimate is formed of the total cost of hiring an additional employee of that type.

707.3 If the value added is sufficiently greater than the cost of the employee (keeping in mind target internal rate of return, capital expenses, hiring costs, etc.) the recommendation is made to hire the employee.

A similar process may be used to determine if the workforce is oversupplied, using the value added by the Nth employee and calculating that against the cost of reducing the workforce through attrition.

Additionally, the process may evaluate the urgency of the tradeoff based on the magnitude of the difference (e.g. a potential value capture of $7 an hour versus $25 an hour; a loss of $5 an hour versus a loss of $20 an hour) to inform decisions about how the workforce change should be accomplished, e.g. 1099 consultants versus hiring, or attrition versus layoffs. A number of other factors, such as recruitment costs, and whether the need is a spike or a long-term trend, and other factors, may be taken into account in making the recommendation.

Furthermore, these Skill Valuations (706) can be used to determine Dual Skill Assignments (708) on the fly. For example, if a group of employees are qualified both to prepare new company computers and to answer help desk requests, which type of task they are assigned can be made to depend on how great the demand is for each skill. That group of employees is thus tasked so as to capture maximum value. When not all of a group with a dual skill set should be tasked to one skill or the other, any of a number of metrics may be used to determine which employees should be tasked with which skill. For example, employees may be re-tasked as they become available, they may be assigned to minimize changes or to re-task people with the least workload in the current task, they may be re-tasked randomly, or based on how quickly they clear the two different types of task (e.g. workstation setup versus helpdesk tickets), their customer or management ratings, their relative level of skill or training in the two tasks, or based on other factors.

FIG. 7B is a flow diagram illustrating an embodiment of a process to determine the value of acquired resources within a firm or other organizational entity. In the example shown, the value of an acquired resource, as indicated by transactions in an internal market used to allocate the acquired resource within the firm and denominated in units of a internal currency or other internal purchasing power asset used to acquire the resource within the firm, is determined (720). An exchange rate, determined for example using one or more of the techniques described herein, is applied to the determined value (722), yielding a value denominated in a currency used by the firm to acquire the resource. For example, if an IT technician's time is valued in the internal market at 50 IT Bucks an hour, and the exchange rate has been determined to be 2 IT Bucks to 1 US Dollar, then the market-determined value to the firm of the IT technician is determined to be $100 US per hour. The computed value is compared to a corresponding cost of acquiring the resource, and if the value exceeds the associated cost, e.g., by more than a threshold amount (724), then more of the resource is acquired. For example, in the foregoing example if the total (incremental) cost of adding another IT technician to the payroll is (significantly enough) less than $100, an additional technician would be hired (or otherwise acquired or assigned). In some embodiments, if the market-indicated value is (significantly) lower than the associated cost, capacity may be reduced and/or reassigned.

### 750 Bottleneck Identification

Commonly available project planning tools (e.g. Microsoft Project) often include a defined set of contingencies, indicating what steps must be completed within a project before another step may be initiated. For example, the specification may need to be written and approved before coding begins. When such contingencies are defined, the Bottleneck Identification (750) system of FIG. 7A is able in some embodiments to sift through the data to identify bottlenecks. For example, if software engineers are currently under-worked, the approval of the specification may be a bottleneck.

By providing better visibility into the amount of work each employee or each type of employee is doing at the firm, it is possible to:

750.1 through the concerted action of the Estimate System, the Market Mechanism, and time tracking, project planning, and other tools, identify employees or other persons who are available, under-worked, or waiting for a project

750.2 identify what project components could be accomplished to clear bottlenecks and create work for these persons

750.3 prioritize these project components above other project components

Through the action of the Valuation System (700) each set of contingencies can be evaluated, at the present moment and into the future, to calculate not just the hours that will be lost if a component is speeded up or if it is delayed, but also the value of those losses. For example, if the action of a manager with the authority to approve software specifications could clear two different bottlenecks, one of which would allow a team of three UI designers to begin work on the next component of Project A and another of which would allow a team of two C Coders to begin work on the next component of Project B, which should be done first? The Delay Cost Calculation (751) computer process can use the overall project valuations, or time-unit valuations of the skill each person is able to provide, to calculate the “economic value” to the firm of accomplishing a given task N time steps earlier or later. For example, if approving the specification is accomplished one day earlier, it may provide for that day higher-value work to the software engineers who are currently clearing low-value projects and so are not currently adding a great deal of value to the firm. Thus, the delay cost of a “negative one day” delay in the specification is the total difference in value between what the software engineers would do without that change versus with that change, plus the total difference in value of all other contingencies changed. In the end, this surplus value represents a high-value project being accomplished earlier and a low-value project being pushed back to a later date, realizing greater value in the current time period.

If Delay Cost Calculations (751) are performed for a number of different project components, Delay Cost Minimization (752) may be performed. This is a process in which a given resource is allocated in such a way as to not merely maximize the value added in this period, but the total value accrued (time-discounted, subjected to probability discount factors, etc.) by allocating resources in the way that puts the greatest value first. This process may be accomplished by calculating contingency-dependent value for each way resources could be allocated; or by another process that is more computationally efficient. The changes may be made automatically (e.g. within Microsoft Project files) or submitted to managers for approval.

Finally, the two methods may be combined in Value Based Bottleneck Identification (753) which identifies specific delays (either positive or negative, i.e. pushing something back in the schedule or moving it up) which can add high levels of value to the firm. These bottlenecks can be automatically cleared, or can be identified for managers to approve the modified schedule.

### 800 Resource Flow System

The Resource Flow System (800) is a system that accepts data from the Valuation System (700) about the relative prices of different types of goods and services across identified types of boundaries (e.g. internal, geographic, corporate) in order to manage flows across these boundaries.

For example, suppose the price of legal help is $220 an hour in a firm's Palo Alto office, while the price in the New York office is only $175. That means, other things being equal, the Palo Alto office's lawyers should focus on the Palo Alto office's needs, while New York office lawyers should mostly be working on New York needs, but some should reduce the excess demand in Palo Alto. By monitoring this relative demand, the firm can minimize some of the costs of sharing resources between offices (e.g. each lawyer splitting time, or some Palo Alto lawyers working for New York clients while others are working the other direction) while gaining the benefits of being able to alleviate temporary demand imbalances.

After the Resource Flow System (800) has identified the imbalance, the Marginal Flow Modulator (801) acts according to the following steps:

801.1 identifies the preferred direction of resource flow for a given resource

801.2 uses a set of predefined rules to compare the level of need to the set of available remedies. For example, a price difference of $10 an hour may result in telecommuting, while a lower price difference does not exceed the inefficiency that results from not having face to face meetings. Alternatively, if a price difference rises to a certain level or a certain level of backlog accumulates (e.g. at least 60 hours of excess work priced $30 above the going rate in New York) the software may seek volunteers to travel (“Who wants to spend a week in California?”) or schedule or extend existing travel plans.

801.3 any necessary approvals are obtained (e.g. by the manager of the set of employees being redeployed)

801.4 the resource pools are adjusted and communicated to the Market Mechanism (100), e.g. “there are now two extra lawyers to be assigned to Palo Alto legal requests”

The Service Exchange (802) extends this concept, allowing resources to be traded across corporate boundaries using pre-established contracting contracts and policies. For example, a firm with in-house counsel and representation by a firm may want to bring in outside lawyers automatically whenever the need exceeds a certain amount, with those lawyers then going into the pool allocated to different internal tasks based on the best fitting skill set. On a broader level, an national flower delivery service may see a spike in delivery needs in one city, at a time when the drivers of a national pizza chain happen to be idle. By integrating information about the fluctuating value of different services within a firm, information from the Valuation System (700) enables flexible cross-firm exchanges of services that would not have been feasible before.

### 900 Business Intelligence Feed

The Business Intelligence Feed (900) is a set of data structures and interfaces that allow information from the Market Mechanism (100), and the other systems connected to it, to be displayed easily to a user. This information may include:

900.1 Large purchases or sales of currency in the Currency Exchange (201)

900.2 Large changes of value in the Currency Valuation System (202)

900.3 Various central banking activities in the Currency Central Banking Services (203), such as changes in interest rates or currency supply

900.4 New contracts listed, contracts closed, large sales or purchases, or fluctuations in price in the Prediction Markets (305)

900.5 Purchases, sales, or fluctuations in price in the Hedge Markets (306)

900.6 Faults encountered within the Fault Definitions (601), or other things that cause large numbers of events to be cleared

900.7 Triggered Bid-Clearing Events (604)

900.8 Large changes in Personal Valuation or Skill Valuation (704 and 706), or unusual valuation levels

900.9 Recommended Workforce Decisions (707)

900.10 Changes in Dual Skill Assignment (708)

900.11 Bottlenecks identified or major scheduling changes made by the Bottleneck Identification systems (750, 753) or by Delay Cost Minimization (752)

900.12 Decisions or recommendations by the Marginal Flow Modulator (801) about internal or external resource flows, or total inter-corporate flows through the Service Exchange (802).

900.13 Other pieces of information related to the internal market at the company

900.14 Other information, e.g. stock quotes, news headlines or news alerts, company notices, virus or technical alerts, scheduled downtime notifications, sports information, data shared or triggered through social networks, voicemail, email, text message, and other communication alerts

This data is displayed within a Feed User Interface (901) any of a set of commonly available feed monitoring systems such as Google Reader, stock tickers or IM systems, Gmail, Facebook's home page, RSS clients such as Safari, etc., or a modification of such a system.

This interface may be displayed in any of a number of User Applications (903) such as email programs, web browsers, Microsoft Outlook, in toolbars, on the desktop, or as a screen saver. It may also be Queried (902) based on type of event or story, topic, company division, employees or projects involved, partner or account, or other search terms. The Feed User Interface (901) will then display stories relevant to that Query (902).

Finally, a Filtering System (904) may be adopted to highlight certain stories for certain users. This system may use any of a number of rules to decide how important or interesting a story is likely to be to a given user, for example:

904.1 watch lists, in which a user defines search terms, projects, individuals, resources, or divisions which are of interest

904.2 past search terms

904.3 information about the individual's position within the company; for example, stories about a project one is assigned to or a resource one manages may be more interesting

904.4 shared data about what type of stories are most often clicked, or how often a given story or stories about a given topic, are clicked by other users

904.5 social data, for example, how often close coworkers click the story or express interest in it

904.6 explicit user feedback, such as clicking a plus icon or rating a story highly (out of four stars or ten points, for example)

904.7 general predictive data found through data mining the interactions between all of the above

904.8 other types of data

Once these data are captured and evaluated, the level of likely interest in any given story may be evaluated, or a list of stories the user is most likely to be interested in can be created. This can be used to sort search placement responsive to a query, or to style events within the feed user interface (e.g. stories that are ranked less important may appear lower, in a different shade or color, may disappear faster or not make it as far across a ticker, etc.). Multiple functions may be measured, e.g. a story more likely to be clicked may move quickly to grab attention, and remain in a central placement, while stories likely to be of interest but not clicked may float evenly along in a lighter color in the background.

Finally, based on any of the data defined above, the Filtering System (904) may dispatch Active BI Alerts (905), for example, text messages, emails, or computer generated phone calls, regarding information the user may be likely to want to know about immediately.

### 1000 Client-Server Interface

In order to enable a user to accomplish the tasks described above, the processes, methods, and apparatuses described above are together can be implemented in the form of a set of interconnected computer components with hardware and software components operably connected to as to enable a user to accomplish these goals.

In order to access the apparatus, the User (1001) uses a User Device (1002) such as a telephone, mobile phone, terminal, personal computer, mobile computer device, or other device capable of receiving input and delivering output to the User. On a more complex Device such as a personal computer, the Device will typically be running a User Application (1003) such as a web browser, Microsoft Outlook, or Microsoft Project, which is configured to display interface elements to the User; on other devices (e.g. a telephone) the interface elements may be communicated directly to the User without a mediating Application.

The User Device (1002) has a Communication System (1005) which is capable of receiving data from or exchanging data with the Server (1050). Such data may include data representing Interface Elements (1006), for example markup, scripts, or code that can be loaded into a web browser to display interface elements; or Interface Elements data may be already loaded onto the internal memory of the Device, for example as a compiled desktop application or plug-in. Such data may further include Application Data (1007), such as information representing how the user may purchase currency, its price, and what accounts may be used to do so; current levels set in the Risk Tolerance Dials; cost estimates, current prices or price history for prediction market contracts, and other types of data. Data exchanged may further include data representing the User Response (1008), indicating, for example, that the User has decided to purchase a specific number of prediction market contracts or to adjust the risk tolerance dials in a certain manner.

The Server (1050) is a single set or multiple sets of operably connected computer components that together have the ability to store data, the ability to store software instructions, the ability to execute software instructions, and the ability to communicate with a user Device (1002). The hardware configuration and software instructions (1051) on the Server are configured to send and receive Interface Elements, Application Data, and User Responses in the manner specified in the foregoing text, so that when used in the manner specified it has the function of integrate a market mechanism with other systems at a firm.

### Other Notes

Embodiments of the present invention include various operations, which are described herein. These operations may be performed by hardware components, software, firmware or a combination thereof. Certain embodiments of the present invention may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or any other type of medium suitable for storing electronic instructions.

Additionally, some embodiments of the present invention may be practiced in distributed computing environments where the machine-readable medium is stored on and/or executed by more than one computer system. In addition, the information transferred between computer systems may either be pulled or pushed across the communication medium connecting the computer systems such as in a remote diagnosis or monitoring system.

Although the operations of the method(s) herein are shown and described in a particular order, the order of the operations of each method may be altered so that certain operations may be performed in an inverse order or so that certain operation may be performed, at least in part, concurrently with other operations. In another embodiment of the present invention, instructions or sub-operations of distinct operations may be in an intermittent and/or alternating manner. Additionally, some operations may be repeated within an iteration of a particular method.

In the foregoing description, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for allocating acquired resources within a firm, comprising:
providing the ability to list acquired resources of a firm on an internal marketplace;
dividing a purchasing power asset among the prospective users of an acquired resource of the firm; and
enabling prospective users of the acquired resource of the firm to attempt to obtain the acquired resource by offering to provide an offered amount of the purchasing power asset in exchange for receiving the acquired resource.

2. The method of claim 1, further comprising
determining the relative value of the purchasing power asset to users of that purchasing power asset, relative to a reference currency, by one or more of:
auctioning an amount of the purchasing power asset to the highest bidder(s) in units of the reference currency
auctioning an amount of the reference currency to the highest bidders in units of the purchasing power asset
creating a fixed exchange rate by which units of the reference currency can be converted into units of the purchasing power asset, or vice versa
measuring the cost in reference currency of services purchased with a given amount of purchasing power asset.

3. The method of claim 2, further comprising determining based at least in part on an amount of the purchasing power asset that has been acquired an amount of the acquired resource to make available to be obtained via the intra-firm market.

4. The method of claim 3, wherein determining based at least in part on an amount of the purchasing power asset that has been acquired comprises determining an amount of the purchasing power asset that has been acquired in a first period and using that amount to determine at least in part how much of the acquired asset to make available during a second period.

5. The method of claim 1, wherein the acquired resource comprises a plurality of component resources and further comprising:
determining a cost associated with the acquired resource by summing component costs associated with the respective component acquired resources;
comparing the offered amount to the determined cost to determine a bid ratio; and
applying the bid ratio to determine for each component a corresponding component pseudo bid amount.

6. The method of claim 5, further comprising generating automatically for each of at least a subset of the component resources a corresponding bid for that component.

7. The method of claim 5, further comprising presenting to the user an interface configured to enable the user to adjust one or more of the component pseudo bid amounts.

8. The method of claim 5, wherein applying the bid ratio to determine for each component a corresponding component pseudo bid amount comprises multiplying each of the respective component costs by the bid ratio.

9. The method of claim 5, wherein applying the bid ratio to determine for each component a corresponding component pseudo bid amount comprises applying the bid ratio to an amount by which the offered amount exceeds the determined cost associated with the acquired resource.

10. The method of claim 1, wherein the acquired resource comprises a first acquired resource and the offered amount comprises a first offered amount; the first offered amount comprises a first bid for the first acquired resource; and the first bid is associated with a second bid comprising a second offered amount offered by the user for a second acquired resource, the first and second bids comprising mutually exclusive alternative requests to meet the same user need; and further comprising using a market mechanism to select zero or one of the first bid and the second bid for fulfillment.

11. The method of claim 10, further comprising storing data associating the first bid and the second bid with a bid set.

12. The method of claim 10, wherein using the market mechanism to select zero or one of the first bid and the second bid for fulfillment includes applying a bargain hunting rule to determine a selected bid to fulfill.

13. The method of claim 10, further comprising receiving an indication that the second bid should be selected for fulfillment if a first difference between the first offered amount and a first market price of first acquired resource is less than a second difference between the second offered amount and a second market price of second acquired resource by more than a threshold amount.

14. The method of claim 10, further comprising receiving an indication that the first bid should be selected for fulfillment if the first offered amount exceeds a first market price of the first acquired resource and no other competing bid for the first acquired resource is higher than the first bid, regardless of whether a first difference between the first offered amount and a first market price of first acquired resource is less than a second difference between the second offered amount and a second market price of second acquired resource by more than a threshold amount.

15. The method of claim 1, further comprising tentatively assigning the acquired resource to fulfill a request with which the offered amount is associated.

16. The method of claim 15, wherein the request comprises a first request and further comprising reassigning the acquired resource to a second request in the event it is determined prior to the first request being cleared for fulfillment that using the acquired resource to fulfill the second request would yield greater value to the firm than would using the acquired resource to fulfill the first request.

17. The method of claim 15, further comprising receiving an indication that the request is to be cleared and assigning the acquired resource to fulfill the request.

18. The method of claim 15, in which the tentative assignment is based on an estimate based on one of past experience, projection, or both past experience and projection, that the request will likely be assigned the acquired resource in the future.

19. The method of claim 2, further comprising comparing the determined value to the firm of the acquired resource with a corresponding cost associated with acquiring the resource.

20. The method of claim 19, further comprising acquiring more of the acquired resources if the determined value exceeds the corresponding cost by more than a threshold amount greater than or equal to zero.

21. The method of claim 19, further comprising reducing a supply of the acquired resources if the determined value is less than the corresponding cost by more than a threshold amount greater than or equal to zero.

22. The method of claim 2, further comprising
a second firm, with a second acquired resource, which acquired resource is similar in character or function to the resource acquired by the first firm, in which a second purchasing power asset is used to bid for said second acquired resource, and in which a second valuation in terms of the same reference currency is set for said second purchasing power asset; and
comparing the market bids for said first and second acquired resource between the two firms in units of the reference currency; and
in a given time period, diverting acquired resources from one of the two firms, in which the value in units of the reference currency is determined to be higher in that time period, into the other of the two firms, in which the value in units of the reference currency is determined to be lower in that time period, in return for a compensatory transfer of money or other consideration of value.

23. A system for allocating acquired resources within a firm, comprising:
a processor configured to:
provide an intra-firm market in which a prospective user of an acquired resource of the firm is able to attempt to obtain the acquired resource by offering to provide an offered amount of a purchasing power asset in exchange for receiving the acquired resource; and
allocate an amount of the purchasing power asset to the user via an auction or other market mechanism that enables an exchange rate for the purchasing power asset relative to a reference currency to be determined; and
a memory coupled to the processor and configured to store data representing an amount of the purchasing power asset that is available in an account associated with the user.

24. A computer program product for allocating acquired resources within a firm, the computer program product comprising a computer readable storage medium having encoded thereon computer instructions for:
providing an intra-firm market in which a prospective user of an acquired resource of the firm is able to attempt to obtain the acquired resource by offering to provide an offered amount of a purchasing power asset in exchange for receiving the acquired resource; and
allocating an amount of the purchasing power asset to the user via an auction or other market mechanism that enables an exchange rate for the purchasing power asset relative to a reference currency to be determined.
